(19) United States
(12) Patent Application Publication
(10) Pub. No.: US 2021/0013768 A1
(43) Pub. Date: Jan. 14, 2021

(54) ELECTRIC MACHINE WITH INTEGRATED COOLING SYSTEM

(71) Applicant: AIRBUS OPERATIONS GMBH, Hamburg (DE)

(72) Inventor: Robert SCHÖLL, Hamburg (DE)

(21) Appl. No.: 16/924,604

(22) Filed: Jul. 9, 2020

(30) Foreign Application Priority Data
Jul. 10, 2019 (EP) 19185549.3

(51) Int. Cl. H02K 5/20; H02K 7/14; H02K 7/18; B64D 33/08; F03D 9/25

(52) U.S. Cl. CPC H02K 5/20; H02K 7/14; H02K 7/1838; F05B 2260/20; F03D 9/25; F05B 2220/706; F05B 2240/60; B64D 33/08

(57) ABSTRACT

An electric machine includes a housing having cylindrical outer walls including a stator portion and a cooling system portion adjacent to the stator portion. The electric machine includes a rotor drive shaft protruding coaxially with the cylindrical outer walls of the electric machine from the front of the electric machine, and a rotor coupled to the rotor drive shaft and arranged coaxially within the stator portion of the cylindrical outer walls of the machine housing. At least one air inlet is formed in the cylindrical outer walls of the machine housing between the stator portion and the cooling system portion. At least one air guide vane extends from the air inlet into a hollow volume of the rotor forming a cooling air duct from the air inlet past the inner surface of the rotor and back to the inner surface of the cooling system portion.

### CROSS-REFERENCE TO RELATED APPLICATION

This application claims priority to EP 19185549.3 filed Jul. 10, 2019, the entire disclosure of which is incorporated by reference herein.

### TECHNICAL FIELD

The disclosure herein pertains to electric machines with integrated cooling systems for cooling parts of the machine and/or power electronics components for controlling the machine. Such electric machines may be employed in housings with ducted fans, for example as electric propulsion unit in a nacelle of a propulsion turbine of an airborne vehicle, as Boundary Layer Ingestion (BLI) propulsion unit in fuselage portions of fuselage-integrated engines or as electric generator in a nacelle of a wind turbine.

Although applicable for any kind of airborne vehicle, the disclosure herein and the corresponding underlying problems will be explained in further detail in conjunction with an aircraft. Airborne vehicles within the meaning of this disclosure include all types of vehicles that may be propelled through the air by force and/or supported by aerodynamic forces.

### BACKGROUND

Electric machines and their components heat up during their operation due to internal losses such as electrical and mechanical losses. Such internal losses lead to elevations in temperature of windings of the electric machine, thereby predominantly contributing to a limitation of the machine rating. Thus, it is desirable to keep the temperature of various components of the machine, and specifically the windings in the machine, under a temperature threshold for enhanced machine efficiency.

For heat to be removed from their source of generation, one of the most efficient methods is to cool the machine components convectively by a circulating or bypassing cooling medium, such as air. Air cooling as one of the simplest and easiest methods is usually sufficiently effective and may be guaranteed by forcing or guiding circulation of air around the components that are sources of heat. Eventually, additional cooling by cooling media with higher density and specific heat capacity, such as silicon oils with low electric conductivity, may be employed on top of the air cooling.

There are many possible ways to provide air cooling to electric machines due to the ease with which heat can be transported convectively. However, conventional installations of cooling systems are not well integrated into the remainder of the machine architecture. Specifically, for high power electric propulsion systems installations of cooling systems do not integrate closely with the components of the machine that are sources of heat generation. Document FR 3 006 996 A1 discloses an electric propulsion assembly for an aircraft comprising a pod in which an electrical propulsion unit is disposed. Between the electric propulsion unit and the pod walls, a duct is defined for creating a cooling airflow when a fan of the electrical propulsion unit creates thrust for the aircraft. Document DE 10 2014 117 962 A1 discloses an electric propulsion system with an electric machine having a rotor with a hollow interior through which a cooling medium may be guided for convective cooling of parts of the rotor.

However, there is a need for improved and space-saving solutions for cooling systems of electric machines that allow for integration into a nacelle in order to protect the cooling system from mechanical damage.

### SUMMARY

According to a first aspect of the disclosure herein, an electric machine with an integrated convective cooling system comprises a machine housing having cylindrical outer walls, the outer walls including a stator portion at the front and a cooling system portion at the back, the cooling system portion lying adjacent to the stator portion. The electric machine further includes a rotor drive shaft protruding coaxially with the cylindrical outer walls of the electric machine from the front of the electric machine, and a rotor coupled to the rotor drive shaft and arranged coaxially within the stator portion of the cylindrical outer walls of the machine housing. At least one air inlet is formed in the cylindrical outer walls of the machine housing between the stator portion and the cooling system portion. At least one air guide vane extends from the air inlet into a hollow volume of the rotor, the at least one air guide vane forming a cooling air duct from the air inlet past the inner surface of the rotor and back to the inner surface of the cooling system portion.

According to a second aspect of the disclosure herein, an electric propulsion system for an airborne vehicle comprises an engine nacelle, a propeller fan installed in the engine nacelle and an electric machine according to the first aspect of the disclosure herein. The electric machine is operable as an electric motor. A fan shaft is coupled to the propeller fan, the rotor drive shaft of the electric machine being connected to the fan shaft.

According to a third aspect of the disclosure herein, an airborne vehicle comprises an electric propulsion system according to the second aspect of the disclosure herein.

According to a fourth aspect of the disclosure herein, an electric energy generation system for a wind turbine comprises an engine nacelle, a turbine fan installed in the engine nacelle, and an electric machine according to the first aspect of the disclosure herein. The electric machine is operable as an electric generator. A fan shaft is coupled to the turbine fan, the rotor drive shaft of the electric machine being connected to the fan shaft.

One idea of the disclosure herein is to form a convective cooling system integrated into an electric machine so that the diameter of the cooling system is not larger than the machine itself. This has the tremendous advantage that a fan propelling or being propelled by the electric machine is not burdened by additional drag. If the electric machine is operated as an electric motor in a high velocity airborne vehicle, such absence of additional drag allows for the most energy efficient operation of the airborne vehicle. Additionally, podded engines in an under-wing configuration largely avoid ground clearance issues when the engine diameter is kept small.

As the integrated cooling system is advantageously located in the aft portion of the machine, the housing of the machine may at least partially shield a heat exchanger of the cooling system from impact damage, such as for example hail or bird strikes.

The configuration of the electric machine is closed in the front and open in the back so that cooling of the rotor is provided for from the back. With this configuration, this can be easily provisioned for: some cooling air for rotor cooling is tapped off close to the heat exchanger, where the majority of cooling air is routed. In this particular case, advantage may be taken of the open volume inside and/or behind the rotor by installing cooling equipment inside and/or closely behind the rotor volume. For example, a liquid reservoir for holding a heat exchanger fluid may be put in this area. Such a liquid reservoir may be advantageously designed to have an outer shape favorable for providing air flow conduit within the rotor volume. As an alternative example, fluid pumping equipment for the heat exchanger may be arranged inside and/or closely behind the rotor volume, particularly if such fluid pumping equipment is very heavy—in such cases, most of the mass of the cooling system may be concentrated roughly in the center of mass of the electric machine so that undesirably long lever arms may be avoided.

One of the advantages of the disclosure herein is that both mechanical as well as air interfaces are simplified in their geometry for the electric machine. As the machine housing needs to be connected to the fan case and the rotor drive shaft coupled to the fan shaft, the only mechanical interface is at the front of the machine. In contrast, the air interfaces are concentrated in the rear part of the machine housing only, with a radial inlet and an axial outlet. Since the cooling system is entirely contained within the electric machine, there is no need for an additional potentially complicated liquid coolant interface.

According to some embodiments of the electric machine, the electric machine may further comprise a heat exchanger integrated into the outer walls of the cooling system portion. In some embodiments, the heat exchanger may include radially or diagonally oriented airflow deflectors. This advantageously allows air to stream through the outer walls of cooling system portion in the location of the heat exchanger.

According to further embodiments of the electric machine, the heat exchanger may be integrated into at least one ring segment of the cylindrical outer walls of the cooling system portion. In some embodiments, the at least one ring segment may span over between about 90° and about 360° of the cylindrical outer walls.

According to some embodiments of the electric machine, the electric machine may further comprise an airflow separation baffle member located concentrically with the outer walls of the cooling system portion within the cooling system portion. In some embodiment, the airflow separation baffle member may form an airflow ring between the outer surface of the airflow separation baffle member and the inner surface of the outer walls of the cooling system portion.

According to some embodiments of the electric machine, this airflow separation baffle member may protrude at least partially into the hollow volume of the rotor.

According to some embodiments of the electric machine, this airflow separation baffle member may enclose a liquid reservoir configured to hold a heat exchanger fluid. The heat exchanger fluid may for example be an appropriate liquid coolant medium.

According to some embodiments of the electric machine, the machine housing may include an axial airflow outlet at the back of the cylindrical outer walls.

According to some embodiments of the electric propulsion system or the electric energy generation system, the systems may include a core housing installed within the engine nacelle. In some embodiments, the core housing may form a first airflow duct between the inner surface of the engine nacelle and the outer surface of the core housing and a second airflow duct between the inner surface of the core housing and the outer surface of the machine housing of the electric machine.

### BRIEF DESCRIPTION OF THE DRAWINGS

The disclosure herein will be explained in greater detail with reference to exemplary embodiments depicted in the drawings as appended.

The accompanying drawings are included to provide a further understanding of the disclosure herein and are incorporated in and constitute a part of this specification. The drawings illustrate the embodiments of the disclosure herein and together with the description serve to explain the principles of the disclosure herein. Other embodiments of the disclosure herein and many of the intended advantages of the disclosure herein will be readily appreciated as they become better understood by reference to the following detailed description. The elements of the drawings are not necessarily to scale relative to each other. Like reference numerals designate corresponding similar parts.

FIG. 1 schematically illustrates a cross-sectional view of an engine nacelle of an electric propulsion system having an electric machine according to some embodiments of the disclosure herein.

FIG. 2 schematically illustrates a cross-sectional view of an electric machine according to other embodiments of the disclosure herein that could be used in an electric propulsion system as shown in FIG. 1.

FIG. 3 schematically illustrates a cross-sectional view of an electric machine according to other embodiments of the disclosure herein that could be used in an electric propulsion system as shown in FIG. 1.

In the figures, like reference numerals denote like or functionally like components, unless indicated otherwise. Any directional terminology like “top”, “bottom”, “left”, “right”, “above”, “below”, “horizontal”, “vertical”, “back”, “front”, and similar terms are merely used for explanatory purposes and are not intended to delimit the embodiments to the specific arrangements as shown in the drawings.

### DETAILED DESCRIPTION

Although specific embodiments have been illustrated and described herein, it will be appreciated by those of ordinary skill in the art that a variety of alternate and/or equivalent implementations may be substituted for the specific embodiments shown and described without departing from the scope of the disclosure herein. Generally, this application is intended to cover any adaptations or variations of the specific embodiments discussed herein.

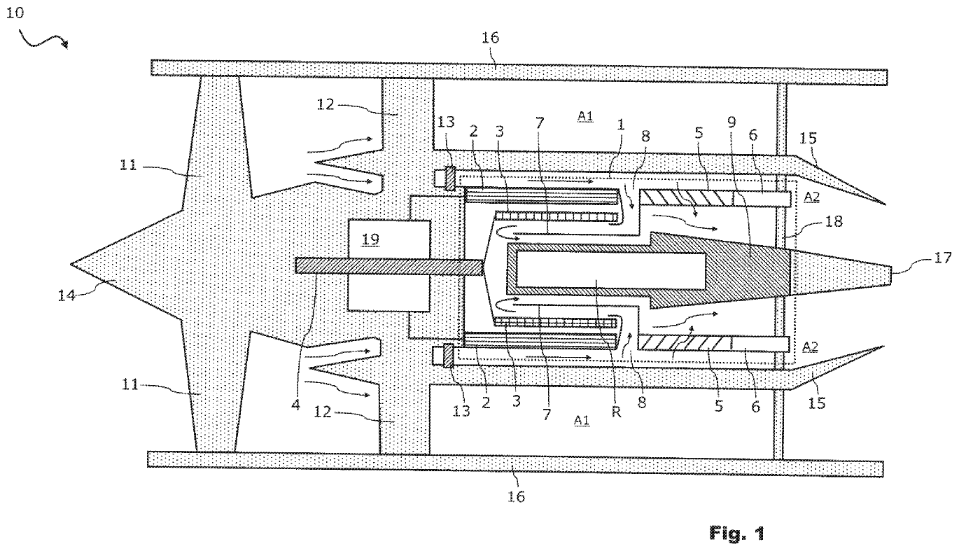

FIG. 1 shows a schematic illustration of a cross-sectional view through an engine nacelle 16. The engine nacelle 16 may be that of an electric propulsion system generally designated 10 having an electric machine 1. Alternatively, the electric machine 1 may be part of an electric energy generation system 10 and the engine nacelle 16 may be a wind turbine nacelle. The electric machine 1 may be operated as an electric motor, i.e. an electrical machine that converts electrical energy into mechanical energy. The electric machine 1 may also be operated as an electric generator, i.e. an electrical machine operating in the reverse direction to an electric motor, thereby converting mechanical energy into electrical energy.

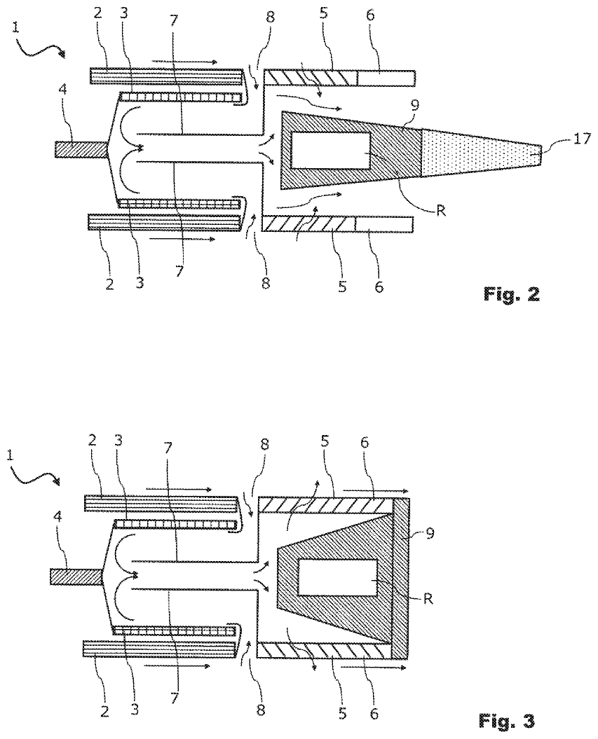

FIGS. 2 and 3 show alternative variations of the electric machine 1 that may be used as a core component within the engine nacelle 16 of the electric propulsion system 10 or the electric energy generation system 10 instead of the electric machine 1 explicitly shown in FIG. 1. It should be understood that distinct features of the variations shown in FIGS. 2 and 3 may be incorporated in the electric machine 1 of FIG. 1 and vice versa. Combinations of features taken from one of the FIG. 2 or 3 with other features taken from the electric machine of FIG. 1 may be used as well.

The electric machine 1 generally includes a machine housing having cylindrical outer walls. These outer walls include a stator portion 2 at the front (without limitation of generality shown to the left-hand side of the drawings) and a cooling system portion 6 at the back (without limitation of generality shown to the right-hand side of the drawings). The cooling system portion 6 lies adjacent to the stator portion 2, i.e. the cooling system portion 6 and the stator portion 2 are part of a commonly formed cylindrical shell, only interrupted by one or more air inlets 8 formed within the outer walls of the machine housing between the stator portion 2 and the cooling system portion 6.

The stator portion 2 may have stator coils or stator windings to be connected to an electric energy storage 19 of the system 10. The electric machine 1 is formed in an in-runner configuration, meaning that there is a rotor 3 coupled to a rotor drive shaft 4, the rotor 3 being generally arranged coaxially within the hollow defined by the stator portion 2 of the machine housing. The rotor 3 may also have magnets, magnetizable coils or windings as appropriate for the type of electric machine.

The rotor drive shaft 4 protrudes coaxially with the cylindrical outer walls of the electric machine 1 from the front of the electric machine 1. This rotor drive shaft 4 may be coupled to a fan shaft connecting to a turbine fan 11 (in case of a wind turbine) or a propeller fan 11 (in case of an electric propulsion system for an aircraft) mounted to a fan rotor hub 14. The propeller or turbine fan 11 may be held in place by support members 12, for example a combined fan stator and support struts, structurally coupling a core housing 15 within the engine nacelle 16. The core housing 15 serves to encapsulate the engine 1 within the nacelle 16. The core housing 15 forms a first airflow duct A1 between the inner surface of the engine nacelle 16 and the outer surface of the core housing 15. A second airflow duct A2 leads between the inner surface of the core housing 15 and the outer surface of the machine housing of the electric machine 1. The dimensioning of the core housing 15 in relation to the machine housing of the electric machine on one hand and the nacelle 16 on the other hand may be chosen such that the ratio between the amount of air passing through the first and second airflow duct, respectively, is controlled as desired. Moreover, there may be adjustable nozzles (not explicitly shown in FIG. 1) installed at or in the support structure 12 so that the ratio between airflow through the two airflow ducts A1 and A2 may be adjusted as desired. It may also be possible to provide an at least partial or complete blockage of the airflow duct A2 at the end of the passage between the cooling system portion 6 and the core housing so that most of the air or all air flowing through the airflow duct A2 is forced through the heat exchanger 5. This could be arranged for by providing ring-shaped blockage elements on the support structure element 18 which interconnects the core housing, the nacelle 16 and the cooling system portion 6 at its aft end. The ring-shaped blockage elements may be partially open for an airflow streaming through or may entirely shut off the outlet between the outer surface of the cooling system portion 6 and the inner surface of the core housing 15 at the aft end of the electric machine Additionally, blower elements 13 may be provided in the airflow duct A2 which act as an airflow booster for air streaming through the airflow duct A2.

Air streaming through the second airflow duct A2 passes on the outside of the machine housing and partially streams radially through the one or more air inlets 8. This partial stream serves as cooling airflow for the rotor. It is guided towards the front past the rotor and cools the rotor components on its way. To that end, there is at least one air guide vane 7 that extends from the air inlet 8 into a hollow volume of the rotor 3. The air guide vane 7 forms a cooling air duct from the air inlet 8 past the inner surface of the rotor 3 and back to the inner surface of the cooling system portion 6. The airflow, having reached the end of the air guide vane 7 within the hollow volume of the rotor 3, is turned by 180° and flows to the back until it reaches the cooling system portion 6.

A heat exchanger 5 is integrated into the outer walls of the cooling system portion 6. The main cooling air flow may enter the heat exchanger 5 from the outside surface of the outer walls of the machine housing may join the rotor cooling airflow to leave the assembly axially through the rear at an axial airflow outlet at the back of the cylindrical outer walls of the machine housing. The heat exchanger 5 may also be split in two or more distinct cooling loops for different components. For example, a first cooling loop of the heat exchanger 5 may be used for cooling the stator parts of the electric machine 1 with a first cooling fluid, while a second cooling loop of the heat exchanger 5 may be used for cooling power electronics components using a second cooling fluid of different type than the first cooling fluid. Further cooling loops may also be used for other heat sources such as the electric energy storage 19 of FIG. 1.

As most of the heat dissipation may be expected to happen in the stator and/or in power electronics components, the heat exchanger 5 may give off heat from the stator and/or the power electronics components. The airflow through the heat exchanger 5 may be radial or diagonal. To that end, the heat exchanger 5 may include radially or diagonally oriented airflow deflectors. The airflow deflectors allow air to stream from the second airflow duct A2 through the outer walls of cooling system portion 6 where the heat exchanger 5 is located. Diagonally running airflow may lead to fewer losses through flow deflection, but might be more complicated to manufacture.

The heat exchanger 5 is integrated into at least one ring segment of the cylindrical outer walls of the cooling system portion 6. This ring segment may span over about 360° of the cylindrical outer walls. Alternatively, there may be more than one ring segment, each ring segment spanning over only a portion of 360° of the cylindrical outer walls. It may also be possible to integrate a heat exchanger 5 in only parts of the outer walls, such as for example spanning about 90° of the cylindrical outer walls. Such configuration may be advantageous if there is additional need for installation space, for example for electric connections or pipework for the fluid pipes for the heat exchanger 5.

As shown in FIGS. 1, 2 and 3, different airflow separation baffle members 9 may be located concentrically with the outer walls of the cooling system portion 6 within the cooling system portion 6. For example, in FIG. 2, the airflow separation baffle member 9 is located entirely within the cooling system portion 6. The airflow separation baffle member 9 allows forming an airflow ring between the outer surface of the airflow separation baffle member 9 and the inner surface of the outer walls of the cooling system portion 6, thereby guiding air streaming back from the air guide vanes 7 towards the inner surfaces of the heat exchanger 5. The airflow separation baffle member 9 aids in creating the necessary airflow velocity difference between the inner side and the outer side of the heat exchanger 5 to have air pass through the heat exchanger 5.

As illustrated in FIG. 1, the airflow separation baffle member 9 may also at least partially protrude into the hollow volume of the rotor 3. For example, the airflow separation baffle member 9 may enclose a liquid reservoir R that is configured to hold a heat transfer fluid for use in the heat exchanger 5. Also, the airflow separation baffle member 9 may enclose other pumping equipment for use with the heat exchanger 5.

The airflow separation baffle member 9 may also close off the back of the machine housing, as illustrated in FIG. 3, so that the rotor cooling air is forced through the heat exchanger 5 back to the second airflow duct A2. This may be advantageous if the rotor needs only little cooling and air radially entering the air inlet 8 is sufficiently cool after having cooled the rotor to cool the stator and/or power electronics components as well. Such a configuration may be favorable for wind turbines aiding in producing a more laminar and stable airflow at the back of the electric machine 1.

The airflow separation baffle member 9 may be coupled to supporting members 17, 18 at the back of the engine nacelle 16 to mechanically stabilize and support the machine housing within the nacelle 16.

The integrated cooling system equipment can be installed with or without shielding. Additional flow guides might help to improve air flow distribution and protect the cooling system equipment, particularly the heat exchanger 5, from the environment. In the case of encapsulated equipment, outside (colder, lower pressure) air could be routed to the cooling equipment for additional cooling. As the cooling system is located close to the electric machine 1, there is less need for extensive piping, thereby reducing weight of the electric machine 1 and balancing pressure distribution in the fluid pumping system of the heat exchanger 5. Also, the proximity of the liquid reservoir R as tank for heat exchanger fluid leads to less entrapped coolant volume, further reducing the necessary tank size and weight.

As any of the electric machines 1 as depicted in FIG. 1, 2 or 3 may be mounted as a unit in an engine nacelle 16, there is no need for breaking open or re-connecting the cooling circuit, therefore eliminating the danger of foreign object damage to the cooling customer. However, if required, the cooling system could be accessed from the rear, for example if required for on-wing maintenance in an electric propulsion system for an airborne vehicle.

Airflow by the fan 13 (or turbine 13) is not impeded by the installation of the cooling system. The electric machine 1 may be installed closely to the fan casing 15 so that cantilever forces are reduced substantially. The cooling system the components of which are generally lighter than components of the electric machine are shifted to the rear of the machine 1, thereby reducing dynamic forces even further.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents. Many other examples will be apparent to one skilled in the art upon reviewing the above specification. In particular, the embodiments and configurations described for the systems and aircraft infrastructure can be applied accordingly to the aircraft or spacecraft according to the disclosure herein and the method according to the disclosure herein, and vice versa.

The embodiments were chosen and described in order to best explain the principles of the disclosure herein and its practical applications, to thereby enable others skilled in the art to best utilize the disclosure herein and various embodiments with various modifications as are suited to the particular use contemplated. In the appended claims and throughout the specification, the terms “including” and “in which” are used as the plain-English equivalents of the respective terms “comprising” and “wherein,” respectively. Furthermore, “a” or “one” does not exclude a plurality in the present case.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An electric machine with an integrated cooling system, the electric machine comprising:
a machine housing having cylindrical outer walls, the outer walls including a stator portion at a front and a cooling system portion at a back, the cooling system portion lying adjacent to the stator portion;
a rotor drive shaft protruding coaxially with the cylindrical outer walls of the electric machine from the front of the electric machine;
a rotor coupled to the rotor drive shaft and positioned coaxially within the stator portion of the cylindrical outer walls of the machine housing;
at least one air inlet formed in the cylindrical outer walls of the machine housing between the stator portion and the cooling system portion; and
at least one air guide vane extending from the air inlet into a hollow volume of the rotor, the at least one air guide vane forming a cooling air duct from the air inlet past an inner surface of the rotor and back to an inner surface of the cooling system portion.

2. The electric machine according to claim 1, further comprising:
a heat exchanger integrated into outer walls of the cooling system portion.

3. The electric machine according to claim 2, wherein the heat exchanger includes radially or diagonally oriented airflow deflectors, allowing air to stream through the outer walls of cooling system portion in a location of the heat exchanger.

4. The electric machine according to claim 2, wherein the heat exchanger is integrated into at least one ring segment of the cylindrical outer walls of the cooling system portion, the at least one ring segment spanning over between about 90° and about 360° of the cylindrical outer walls.

5. The electric machine according to claim 1, further including:
an airflow separation baffle member located concentrically with outer walls of the cooling system portion within the cooling system portion, the airflow separation baffle member forming an airflow ring between an outer surface of the airflow separation baffle member and the inner surface of outer walls of the cooling system portion.

6. The electric machine according to claim 5, wherein the airflow separation baffle member protrudes at least partially into the hollow volume of the rotor.

7. The electric machine according to claim 5, wherein the airflow separation baffle member encloses a liquid reservoir configured to hold a heat exchanger fluid.

8. The electric machine according to claim 1, wherein the machine housing includes an axial airflow outlet at the back of the cylindrical outer walls.

9. An electric propulsion system for an airborne vehicle, the electric propulsion system comprising:
an engine nacelle;
a propeller fan installed in the engine nacelle;
an electric machine according to claim 1, the electric machine being operable as an electric motor; and
a fan shaft coupled to the propeller fan, the rotor drive shaft of the electric machine being connected to the fan shaft.

10. The electric propulsion system according to claim 9, further comprising:
a core housing installed within the engine nacelle, the core housing forming a first airflow duct between an inner surface of the engine nacelle and an outer surface of the core housing and a second airflow duct between an inner surface of the core housing and an outer surface of the machine housing of the electric machine.

11. An airborne vehicle, comprising an electric propulsion system according to claim 9.

12. An electric energy generation system for a wind turbine, the electric energy generation system comprising:
an engine nacelle;
a turbine fan installed in the engine nacelle;
an electric machine according to claim 1, the electric machine being operable as an electric generator; and
a fan shaft coupled to the turbine fan, the rotor drive shaft of the electric machine being connected to the fan shaft.

13. The electric energy generation system according to claim 12, further comprising:
a core housing installed within the engine nacelle, the core housing forming a first airflow duct between an inner surface of the engine nacelle and an outer surface of the core housing and a second airflow duct between an inner surface of the core housing and an outer surface of the machine housing of the electric machine.
